(19) United States
(12) Patent Application Publication
(10) Pub. No.: US 2012/0211442 A1
(43) Pub. Date: Aug. 23, 2012

(54) Cleaning System

(75) Inventor: Neville Ernest Lange, Glouchestershire (GB)

(73) Assignee: VWS Westgarth Limited, Gloucestershire (GB)

(21) Appl. No.: 13/033,155

(22) Filed: Feb. 23, 2011

(30) Foreign Application Priority Data
Feb. 18, 2011 (GB) 1102851.1

(51) Int. Cl. B01D 21/26

(52) U.S. Cl. 210/787; 210/512.1; 210/194; 210/512.3; 210/198.1; 210/202

(57) ABSTRACT

The invention relates to a cleaning system for hydrocyclone sand cleaning comprising a hydrocyclone for receiving a slurry containing sand to be cleaned and a vessel for receiving sand exiting the hydrocyclone, wherein the vessel has an discharge port for the sand. A fluid extractor is provided between the hydrocyclone and the discharge port, for extracting fluid from the vessel to permit an increased flow rate of sand into the vessel. The invention also relates to a method of cleaning sand and a method of increasing the flow rate of sand through a hydrocyclone cleaning system such as that described above.

### FIELD OF THE INVENTION

This invention relates to a cleaning system. Particularly, but not exclusively, the invention relates to a cleaning system for hydrocyclone sand cleaning as described below and a method of increasing the flow rate of sand through a hydrocyclone cleaning system.

### BACKGROUND TO THE INVENTION

When oil is produced from a subterranean oil reservoir, it is generally accompanied by gas, water and solids. Most of the solids are fragments of the reservoir “rock” carried up from the reservoir by the flow of oil, water and gas, and this portion of the solids is generally termed “sand”. Other solids may be scale and corrosion products, but these portions of the solids are usually very small in comparison to the sand.

As the sand is heavier than the water or oil, it generally settles to the bottom of any vessels or piping or flow passage where the liquid velocity is not high enough to keep it in suspension. Most oil production systems separate the valuable oil and gas from the water in large vessels called Separators in which the flow of fluids is stilled and allowed to reside for long enough for the gas, oil and water to separate by gravity and as a consequence if sand is also produced from the well it will settle in this vessel as well. The sand cannot be allowed to accumulate beyond a permissible quantity because it interferes with the operation of the vessel. The settled sand reduces the volume of the vessel available for the fluids and hence reduces their residence time in the vessel, therefore adversely affecting the efficiency of the fluid separation.

The conventional way of coping with the sand which settles in Separators is to allow it to accumulate to a maximum acceptable level over a long period and then remove it during a much shorter period. The removed sand often has a quantity of oil adhering to its surface and is usually removed from the Separator as a slurry formed with the produced water, which itself also contains a small amount oil. The sand usually has to be processed to remove at least a portion of the adhering oil so that it is clean enough for disposal or other use. This process is called “Sand Cleaning” or “Sand Washing”.

It is becoming common that oil production systems also have hydrocyclone separators that receive the water phase from the Separators described above. The purpose of these hydrocyclone separators is to remove further sand from the water phase before it goes for subsequent processing. The sand which accumulates in the hydrocyclone separator is another source of sand which may require sand cleaning.

Sand which requires cleaning may also accumulate in other locations in the production system.

One method commonly used for cleaning the above accumulations of sand is a hydrocyclone sand cleaning system. The principle of such a system is that the oily sand is formed into a slurry of a suitable concentration with water and is passed through a hydrocyclone. Within the hydrocyclone the sand particles undergo considerable abrasion as they rub against themselves and the walls of the hydrocyclone which tends to scrub the adhering oil from the sand particles and transfer it into the water phase. The water phase containing the oil is separated from the sand and discharged via an overflow port of the hydrocyclone, and the sand is discharged via an underflow port of the hydrocyclone, typically into a collecting or cleaning vessel. The sand may then be removed from the collecting or sand holding vessel via a lower discharge port. It may be necessary to pass the sand through the hydrocyclone several times to clean it adequately, particularly if the slurry is cool (e.g. 20° C.) or the oil is of a low API gravity (e.g. 11° API) or it has waxes or other sticky solid or semi solid constituents.

Several separate stages of the sand cleaning process can be identified as follows:

(i) a first “Collection Stage” when sand is transferred into the collecting vessel from the various vessels in the production system in which it has accumulated;

(ii) a second “Cleaning stage” where the sand is cleaned; and

(iii) a third “Discharge stage” where the sand is discharged from the system.

During the Collection Stage the hydrocyclone operates in what is called “zero net underflow” or “potted underflow” mode such that sand is passed through the hydrocyclone and is collected below in the collecting vessel. However, there is no flow out of the vessel during this stage in order to permit accumulation of the sand, and as such if a volume of sand is to enter the vessel from the underflow port of the hydrocyclone, then an equal volume of fluid (e.g. water) has to exit the vessel via the same underflow port. The returning fluid flow reduces the separation efficiency of the hydrocyclone and reduces the effective cross-sectional area through which the sand can flow into the vessel. This leads to there being a maximum concentration of sand that the hydrocyclone can separate when in zero net underflow mode and this can be problematic because the amount of sand in the slurry delivered to the sand cleaning system cannot be easily or reliably limited to what the hydrocyclone can separate.

### SUMMARY OF THE INVENTION

According to a first aspect of the present invention there is provided a cleaning system for hydrocyclone sand cleaning, comprising:
a hydrocyclone for receiving a slurry containing sand to be cleaned;
a vessel for receiving sand exiting the hydrocyclone and having a sand discharge port for permitting sand to be discharged from the vessel; and
a fluid extraction arrangement configured for extracting fluid from the vessel at a location between the hydrocyclone and the sand discharge port to permit an increased flow rate of sand into the vessel.

It should be understood that sand may include any particulate matter, such as particulate matter created during oil and gas exploration and production activities.

The hydrocyclone may be configured for receiving a slurry composed at least of sand to be cleaned and a fluid, such as water.

The hydrocyclone may comprise an underflow port for permitting sand to exit the hydrocyclone to be received within the vessel. The hydrocyclone may comprise an overflow port for permitting predominantly a fluid phase, such as water, separated from the slurry to exit the hydrocyclone.

Embodiments of the present invention may provide a cleaning system which, by allowing an increased flow rate of sand into the vessel, increases the amount of sand the hydrocyclone can separate and may also increase the separation efficiency. In addition, less sand is likely to be inadvertently passed to other parts of the system, for example, via water exiting an overflow port of the hydrocyclone. Accordingly, the costs associated with sand induced wear and providing sand handling capability in other parts of system may be reduced or eliminated.

The extracted fluid may largely comprise water or other liquids.

The fluid extraction arrangement may comprise or define an extraction port located between the hydrocyclone and the sand discharge port. The extraction port may be located so as to extract fluid which is largely sand-free (e.g., the extraction port may be located above an expected maximum level of sand when it has accumulated in the vessel). The extraction port may be provided in an upper portion of the vessel. In certain embodiments the extraction port may be provided at or adjacent the top of the vessel. The extraction port may be formed or provided on a wall of the vessel. Alternatively, or additionally, the extraction port may be defined within the vessel, such as by a conduit which is located or extends within the vessel. For example, the extraction port may be defined by an open end of a conduit, one or more perforations in a wall of a conduit or the like. The fluid extraction arrangement may comprise or define a device or structure configured to minimise the amount of sand removed with the extracted fluid, such as a filter arrangement or the like.

The fluid extraction arrangement may comprise an extraction conduit or pipe system extending from the vessel, for example extending from an extraction port on or within the vessel. The extraction conduit system may comprise a single conduit, a series or network of conduits, flow equipment, or the like.

The fluid extraction arrangement may be configured to discharge fluid extracted from the vessel from the cleaning system, for example to be disposed of, used in a different process, further treated or the like.

The fluid extraction arrangement may be configured to recycle at least a portion of fluid extracted from the vessel within the cleaning system. For example, the fluid extraction arrangement may be configured to feed extracted fluid into the sand slurry prior to or on entry of the slurry into the hydrocyclone. In such an arrangement the extracted fluid, which is largely formed of sand-free liquid, will dilute the slurry to a lower sand concentration thereby allowing the hydrocyclone to more efficiently separate the sand from the slurry. In certain embodiments, the dilution of the slurry may allow the processing of slurries having a higher initial concentration of sand.

The fluid extraction arrangement may be configured to permit passive extraction of fluid from the vessel. For example, the fluid extraction arrangement may permit fluid to naturally flow from the vessel, for example by allowing the fluid to flow to a destination at a lower pressure.

The fluid extraction arrangement may be configured to permit active extraction of fluid from the vessel.

The fluid extraction arrangement may comprise flow control equipment configured to draw fluid from the vessel, for example actively draw fluid from the vessel. The fluid extraction arrangement may comprise a fluid drive apparatus or means. The fluid extraction arrangement may comprise a dedicated fluid drive apparatus or means, for example a drive apparatus or means provided exclusively for use in actively extracting fluid from the vessel. The fluid extraction arrangement may comprise or utilise a shared fluid drive apparatus or means, such as an apparatus or means which may be used to actively transport or drive a fluid, slurry, particulate matter or the like in addition to actively extracting fluid from the vessel.

The fluid drive apparatus or means may define an inlet configured to receive or extract fluid from the vessel, and an outlet. The outlet may be configured to discharge fluid from the cleaning system, recycle fluid within the cleaning system, or the like.

The fluid extraction arrangement may comprise an eductor. The eductor may define a suction port in fluid communication with the vessel, such that the eductor may draw or extract fluid from the vessel. The eductor may define a motive fluid port in fluid communication with a motive fluid source. The motive fluid source may comprise an external fluid source, fluid from the hydrocyclone, for example from an overflow port of the hydrocyclone, or the like. In certain embodiments the motive fluid source may be pressurised, for example by pumping. For example, fluid from an overflow port of the hydrocyclone may be pumped to the motive fluid port of the eductor. The eductor may define a delivery port configured to deliver a mixture of extracted fluid and motive fluid therefrom.

The fluid extractor arrangement may comprise a pump, such as a rotodynamic pump, positive displacement pump or the like. The pump may define a suction port in fluid communication with the vessel to permit the pump to extract fluid from the vessel. The pump may define a delivery port configured to deliver extracted fluid therefrom.

The system may further comprise a sand extraction arrangement configured for use in extracting sand from the vessel via the sand discharge port. The sand extraction arrangement may comprise a drive apparatus or means in communication with the sand discharge port. The drive apparatus of the sand extraction arrangement may be associated with the fluid extraction arrangement. For example, a common drive apparatus, means or arrangement may be configured for both extracting fluid as a function of the fluid extraction arrangement, and extracting sand as a function of the sand extraction arrangement. In one embodiment the common drive apparatus may comprise a source of motive fluid.

The sand extraction arrangement may comprise an eductor or a pump arranged to extract sand through the discharge port of the vessel. A fluid input may be provided to assist the flow of sand through the sand extraction arrangement. The fluid input may be connected to an external fluid supply, an overflow port of the hydrocyclone and/or a discharge or output of the fluid extractor arrangement. The fluid input may be pumped. A fluid treatment device may be connected to the fluid input to clean fluid flowing from the external fluid supply, the overflow port of the hydrocyclone and/or the fluid extractor arrangement.

The cleaning system may be configured to operate in multiple modes of operations. The cleaning system may be configured to operate in a collecting mode, in which the sand extraction arrangement is not operated and sand form the incoming slurry is accumulated in the vessel. The fluid extraction arrangement may be operated during the collecting mode to extract fluid from the vessel and thereby allow an increased rate of sand to pass into the vessel from the hydrocyclone.

The cleaning system may be configured to operate in a cleaning mode, in which the sand extraction arrangement is operated and the output from which may be fed back into the hydrocyclone continuously until such time as the sand is deemed to be sufficiently ‘clean’ (i.e. when a sufficient proportion of oil has been extracted from the sand and passed with water through an overflow of the hydrocyclone). The fluid extraction arrangement may be operated during the cleaning mode to increase the rate of sand exiting the hydrocyclone and, in some instances, to also dilute the slurry fed into the hydrocyclone (which, in this mode, will comprise the output from the sand extraction arrangement). Thus, the fluid extraction arrangement may increase the separation efficiency of the hydrocyclone.

The cleaning system may be configured to operate in a discharge mode, in which the sand extraction arrangement is operated and the output from which is discharged from the cleaning system. The fluid extraction arrangement may or may not be operated during the discharge mode.

According to a second aspect of the present invention there is provided a method of cleaning sand, comprising:
feeding a slurry containing sand to be cleaned into a hydrocyclone;
allowing sand to exit the hydrocyclone into a vessel below, the vessel having a discharge port for the sand; and
extracting fluid from the vessel from a position between the hydrocyclone and the discharge port to permit an increased flow rate of sand into the vessel.

The method may permit an increased flow rate of both sand and fluid from the hydrocyclone into the vessel.

The fluid may be extracted from an upper portion of the vessel. In certain embodiments the fluid may be extracted from a port at or adjacent the top of the vessel.

The method may further comprise diluting the slurry prior to or on feeding the slurry into the hydrocyclone. The slurry may be diluted by the extracted fluid.

The method may be employed in a cleaning system such that described above, when operating in one or more of a collecting mode, a cleaning mode or a discharge mode.

The method may employ use of the cleaning system described above and it should be understood that features, in combination or in isolation, defined or implied may apply to the method according to the second aspect.

Other aspects of the present invention may relate to a method of increasing the flow rate of sand through a hydrocyclone cleaning system.

### BRIEF DESCRIPTION OF THE DRAWINGS

Embodiments of the invention will now be described with reference to the accompanying drawings in which:

FIG. 1 illustrates a cleaning system employing an eductor as a fluid extractor in accordance with a first embodiment of the invention;

FIG. 2a shows a cross-sectional elevation view of an underflow portion of a hydrocyclone, when the fluid extractor of the present invention is not in use;

FIG. 2b shows a cross-sectional plan view of the underflow portion shown in FIG. 2a, when the fluid extractor of the present invention is not in use;

FIG. 3 illustrates a sand concentration profile that would typically occur when discharging sand from a vessel;

FIG. 4 illustrates a cleaning system employing a pump as a fluid extractor in accordance with a second embodiment of the invention;

FIG. 5 illustrates a cleaning system employing flow control equipment as a fluid extractor in accordance with a third embodiment of the invention, wherein the flow control equipment is configured to pass its output back into the system;

FIG. 6 illustrates a cleaning system employing flow control equipment as a fluid extractor in accordance with a fourth embodiment of the invention, wherein the flow control equipment is configured to discharge its output from the system; and

FIG. 7 illustrates a cleaning system employing a sand extractor pump and a fluid extractor in accordance with a fifth embodiment of the invention.

### DETAILED DESCRIPTION OF CERTAIN EMBODIMENTS

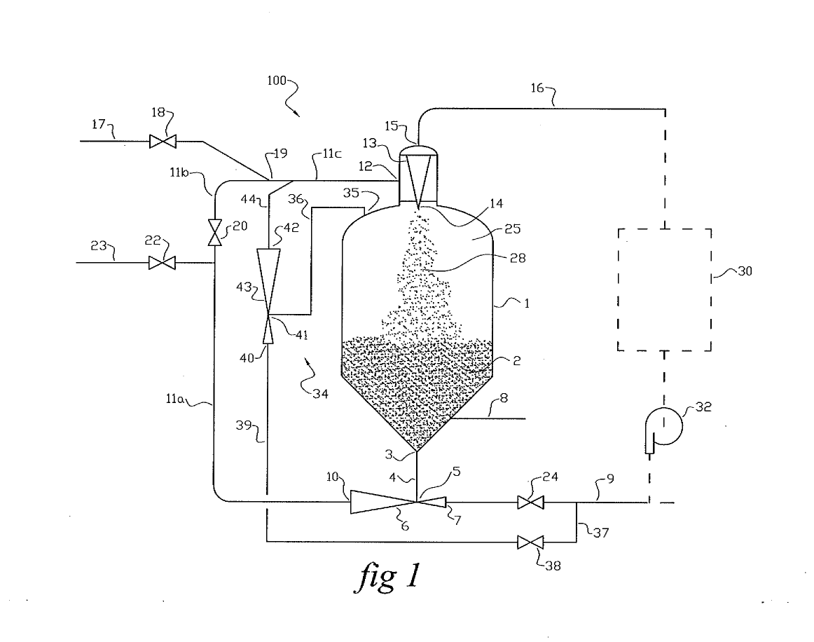

A cleaning system 100 for hydrocyclone sand cleaning in accordance a first embodiment of the present invention is shown in FIG. 1. The system 100 comprises a vessel 1 which, in use, contains sand 2 which is to be cleaned. Such sand may include particulate matter created during oil and gas exploration and production activities, such as during drilling of a wellbore, production from a subterranean formation or the like.

The bottom of the vessel is substantially conical (although other shapes, such as dished, may be utilised) and terminates in a solids discharge port 3, wherein the discharge port 3 is connected via a conduit 4 to a “suction” port 5 of a sand extractor in the form of an eductor 6. The vessel 1 includes a fluid input means 8 arranged to introduce additional water to the sand to partially fluidise the sand so that it flows more easily into to the sand extractor. The eductor 6 is fed with high pressure motive water from a motive water pipe 9 connected to motive water port 7. A valve 24 is provided in motive water pipe 9 to control flow into and out of the motive water port 7 of the eductor 6, when required. A discharge port 10 of eductor 6 connects via piping 11a to a valve 20 and then through piping 11b, 11c to an inlet 12 of a hydrocyclone 13 mounted on top of the vessel 1.

An underflow port 14 of the hydrocyclone 13 discharges into the vessel I and an overflow port 15 of the hydrocyclone 13 discharges into piping 16. The piping 16 may carry the overflow products from the hydrocyclone 13 (i.e. water and oil) away from the cleaning system 100 for further processing. However, as shown in dashed lines in FIG. 1, in embodiments of the invention, the piping 16 may carry the overflow products to a treatment stage 30, which may separate the water from the oil, before the water is passed through a pump 32 to increase its pressure prior to entering the motive water pipe 9. Thus, the overflow water may be recycled and used as the high pressure water fed to the motive water port 7 of the eductor 6. In other embodiments, the high pressure motive water may come from a source external to the hydrocyclone sand cleaning system 100.

The treatment stage 30 may be configured for one or more of the following treatments: heating, removal of oil with hydrocyclones or coalescers or absorbing media, addition of chemicals filtering, settling or the like. In certain embodiments, the treatment stage 30 and/or the pump 32 may integrated into an equipment package with the hydrocyclone sand cleaning system 100.

Although the hydrocyclone 13 is described in the singular, the flow which the cleaning system 100 has to treat may require the hydrocyclone 13 to actually consist of several hydrocyclones 13 operating in parallel, and similarly references to the underflow port 14 and the overflow port 15 of the hydrocyclone 13 should be construed to refer to the respective underflow ports and overflow ports of all of the hydrocyclones 13 provided.

An input pipe 17 is connected to various vessels in a process system in which sand can accumulate and is used to deliver the sand in a slurry to the cleaning system 100. A valve 18 is provided in the input pipe 17 to allow the flow into the system 100 when required. Furthermore, in this embodiment, input pipe 17 is configured to join with piping 11b at a junction 19, prior to piping 11c which connects to the inlet 12 of the hydrocyclone 13.

An output pipe 23 is provided in piping 11a, upstream of valve 20, to deliver sand from the cleaning system 100 to a sand discharge point. Accordingly, valves 18, 20 and 22 are opened or closed to direct the flow of sand slurry through pipes 11a, 11b, 11c, 17 and 23.

In accordance with the present embodiment of the invention, the system 100 further comprises a fluid extractor 34. The fluid extractor 34 comprises an extraction pipe 36 extending from an extraction port 35 provided on the vessel 1. The extraction port 35 is located on the top surface of the vessel 1 so that it draws relatively sand-free water from the top of the vessel 1 rather than sand slurry issuing from the underflow port 14 of the hydrocyclone 13. The fluid extractor further comprises an eductor 43 configured to draw high pressure motive fluid from the high pressure motive water pipe 9, through a pipe 37, valve 38 and pipe 39 to a motive water port 40 of the eductor 43. The extraction pipe 36 is connected from the extraction port 35 in the vessel 1 to a suction port 41 of the eductor 43. A discharge pipe 44 is provided from a discharge port 42 of the eductor 43. In this particular embodiment, the discharge pipe 44 is connected to the piping 11b which feeds back into the inlet 12 of the hydrocyclone 13.

It should be noted that the capacity of the hydrocyclone 13 in the present embodiment has been increased to handle the additional flow which eductor 43 will provide, during use.

Operation During the Collection Stage—Without the Fluid Extractor

In order to illustrate the advantages of the present embodiment of the invention, we will first consider the operation of the cleaning system 100, when the fluid extractor 34 is not in use. This situation is equivalent to that experienced in prior art systems.

During the collection stage valves 24, 22 and 20 are closed and valve 18 is opened. Accordingly, no sand 2 is drawn out of the vessel 1, no flow is allowed to exit the system via outlet pipe 23 and no flow is allowed to re-enter the hydrocyclone 13 via piping 11b, 11c. However, a sand slurry comprising sand accumulated in vessels in a production system is permitted to flow through inlet pipe 17 and via pipe 11c to the inlet 12 of the hydrocyclone 13. The hydrocyclone 13 should ideally separate all of the sand 2 from the slurry and deliver it into the vessel 1 via the underflow port 14, with the water phase of the slurry being delivered to the overflow port 15 and then into pipe 16 which carries it away from the hydrocyclone 13.

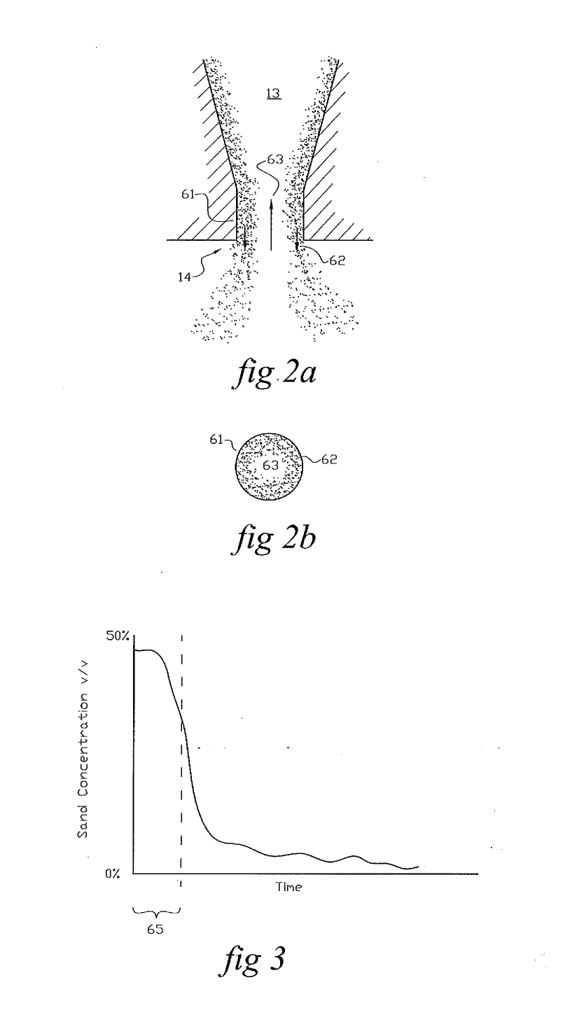

As shown in FIGS. 2a and 2b, when the quantity of sand in the hydrocyclone 13 is not too great it tends to flow through the underflow port 14 in a region 62 against the lower wall of the port 61 allowing water to return through the centre of the port 63. However this returning fluid flow reduces the separation efficiency of the hydrocyclone 13 and reduces the maximum flow rate of separated sand simply because the sand cannot exit through the full cross-sectional area of the underflow port 14. This is a source of an inherent short-coming in this stage of the hydrocyclone sand cleaning system because the hydrocyclone 13 does not separate the sand as well in zero net underflow mode as it does when there is a net flow from the underflow port 14 and the flow rate of sand it can separate through the underflow port 14 is much reduced. It has been suggested that the hydrocyclone 13 may only be able to separate sand at an inlet concentration of 5% to 10% by volume in this zero net underflow mode.

Moreover, it has been found that for inlet concentration greater than the above, the excess sand will pass through the overflow port 15 which is highly undesirable because it makes the treatment of that stream more complicated and expensive. For example, valves and pumps will wear more quickly when sand is present, and further vessels into which the fluids flow will accumulate sand and therefore require sand removal systems to ensure the sand does not affect subsequent processes.

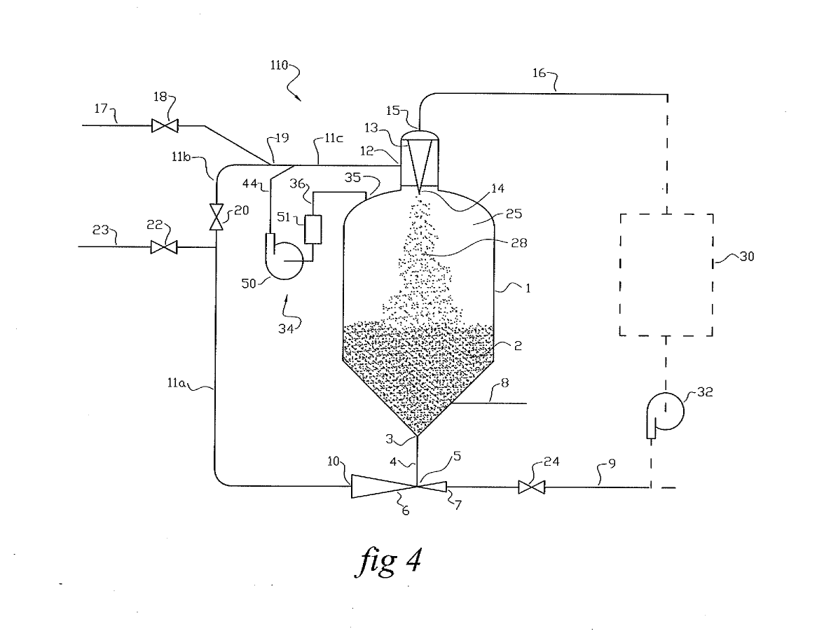

FIG. 3 shows a profile of sand concentration which is typical of the sand concentration obtained from a Separator. During an initial period denoted 65, which may last only a few seconds or minutes at the beginning of the sand removal process, the concentration of sand which would be fed to the hydrocyclone 13 is high (for example 25 to 50% v/v). This occurs while the sand discharge ports of the separator are covered with sand. When the ports are not fully covered with sand, the concentration drops rapidly as water preferentially flows into the ports and the sand concentration may then fall to 2 to 5% v/v or less.

One method to alleviate this problem is to dilute the slurry obtained from the Separator to reduce the sand concentration. While this can work it is easy to see that it will increase the cost and size of equipment because the hydrocyclone 13 and all subsequent treatment equipment must be bigger to accept the larger flow rate.

Operation During the Sand Cleaning Stage—Without the Fluid Extractor

Referring back to FIG. 1, during the sand cleaning stage valves 18 and 22 are closed and valves 20 and 24 are opened. Accordingly, no new slurry is accepted into the system from inlet pipe 17, and no flow is allowed to exit the system via outlet pipe 23. However, high pressure motive water is allowed to feed into the motive water inlet port 7 of the eductor 6, sand 2 is permitted to be drawn out of the vessel 1 at low pressure and into the eductor 6 via conduit 4, and a slurry at an intermediate pressure is discharged from the eductor 6 through discharge port 10. The concentration of sand in the slurry is set by the flow rate of the motive water and the flow rate of sand drawn into the eductor 6, and it is a characteristic of the eductor 6 that these flow rates are predictable and repeatable provided that the pressures in the system 100 do not change.

The slurry is then delivered by piping 11a, through valve 20, to piping 11b, 11c and from there the slurry is allowed to re-enter the hydrocyclone 13 mounted on the top of the vessel 1. While passing through the hydrocyclone 13 the sand is abraded against itself and the walls of the hydrocyclone 13 which tends to scrub adhering oil from the surface of the sand particles and transfer it into a water phase. The hydrocyclone 13 separates the majority of the sand fed to its inlet 12 to the underflow port 14 and the majority of the water, which contains the remainder of the sand and most of the oil scrubbed from the sand, to the overflow port 15. The sand slurry exiting the underflow port 14 of the hydrocyclone 13 falls through water 25 provided in the top of the vessel 1 and settles at the bottom of the vessel 1 on top of any sand 2 already in the vessel 1. The sand falling from the underflow port 14 into the vessel 1 is represented by 28 in FIG. 1.

The system 100 described above can operate continuously and sand may be formed into a slurry by the eductor 6 and then separated and scrubbed in the hydrocyclone 13 as many times as is necessary to reduce the adhering oil to a desired level.

During the sand cleaning stage the hydrocyclone 13 operates with a net underflow because the eductor 6 is continually drawing a volume out of the vessel 1 which can only be replaced by continually drawing an equal volume from the underflow port 14 of the hydrocyclone 13. Because the volume which the eductor 6 is drawing from the vessel 1 will be a sand slurry with a concentration of about 40 to 60% by volume, if the hydrocyclone 13 separates all this sand from its input 12 then the same concentration of sand will exist in the underflow port 14. While it is possible to operate a hydrocyclone 13 with an underflow port 14 having such a concentration of sand it is desirable to increase the net underflow from the hydrocyclone 13 so that the underflow concentration is reduced as this can improve the efficiency of the hydrocyclone 13, therefore reducing the amount of sand lost out the hydrocyclone overflow 15.

Operation During the Discharge Stage—Without the Fluid Extractor

The discharge of sand from the cleaning system 100 can be achieved in a number of ways but only one method will be described below for conciseness.

During the Discharge Stage valves 20 and 18 are closed and valves 24 and 22 are open. Accordingly, no new slurry is allowed to enter the cleaning system 100 and no flow is allowed to re-enter the hydrocyclone 13 via piping 11b, 11c. However, sand is permitted to be drawn out of the vessel 1 and delivered to the outlet pipe 23.

More specifically, water at a suitable (high) pressure is fed to the motive water port 7 of the eductor 6. The eductor 6 also draws sand 2 via conduit 4 from the vessel 1 at low pressure and discharges a slurry formed from the sand and motive water at an intermediate pressure from its discharge port 10 into pipe 11a. The slurry is forced to flow out of the system 100 via outlet pipe 23 since valve 20 is closed. Fluid to replace the volume withdrawn from the vessel 1 by the eductor 6 may be admitted to the vessel 1 by the fluid input means 8 to fluidise the sand 2 in the vessel 1, by reverse flow in pipe 16, by fluid flow via pipe 17, or by some other means not shown.

Operation with the Fluid Extractor

In accordance with embodiments of the present invention, the fluid extractor 34 may be operated during one or more of the sand collection stage, the sand cleaning stage and the discharge stage. In particular embodiments, the fluid extractor 34 is operated during both the sand collection and sand cleaning stages.

During operation of the fluid extractor 34, high pressure water from motive water pipe 9 is permitted to flow through valve 38 and pipe 39 into the motive water inlet port 40 of the eductor 43 at a flow rate which shall be identified as Q_{M}, thereby sucking a flow of relatively sand free water at a flow rate which shall be identified as Q_{S}, from the extraction port 35 at low pressure into the suction port 41, before the eductor 43 discharges both waters from the discharge port 42 at an intermediate pressure into pipe 44. The flow from pipe 44 is then permitted to flow into pipe 11c joining slurry already in this pipe so as to dilute the slurry before it flows into the inlet 12 of the hydrocyclone 13.

The configuration of the above fluid extractor 34 has two main effects on the operation of the hydrocyclone 13. Firstly the flow rate of slurry drawn into the vessel 1 from the underflow 14 of the hydrocyclone 13 is increased by Q_{S}, and secondly the slurry fed into the hydrocyclone 13 is diluted to a lower sand concentration by the addition of the motive water of flow rate Q_{M} and the relatively sand free water drawn from the vessel 1 at flow rate Q_{S}. One benefit that this provides is that reducing the sand concentration in the slurry fed into the hydrocyclone 13 allows the hydrocyclone 13 to more efficiently separate the sand from the slurry. In addition, operating the hydrocyclone 13 with a larger net underflow increases the amount of sand the hydrocyclone can separate (for a given flow rate) and therefore increases the separation efficiency of the hydrocyclone 13.

### NUMERICAL EXAMPLE 1

An approximate calculation will be described below in order to illustrate the increased sand capacity of the hydrocyclone 13 during the collection stage, as provided by aspects of the present invention.

We can assume that during the collection stage, a hydrocyclone sand cleaning system has 9 cyclones each with an underflow port 14 diameter of 33 mm such that they can separate the sand in a slurry flow of 90 m³/h with a sand concentration of 5% v/v when running in zero net underflow mode.

To allow a comparison with the present invention to be carried out, the following assumptions are also made:
1. That when in continuous underflow a slurry of 55% concentration is drawn through the underflow port 14 of the hydrocyclone 13; and
2. Eductor 43 is operated so that the flow rate Q_{S} is 20% of the feed flow through inlet 12 for which a motive water flow Q_{M} of 20% of the feed flow is required.

The sand capacity when each hydrocyclone 13 is operating in zero net underflow mode can be determined by multiplying the feed flow rate by the feed concentration (i.e. 10 m³/h*5% v/v=0.5 m³/h). Thus, when the 9 hydrocyclones 13 are employed, this gives a total sand flow of 9*0.5=4.5 m³/h through the underflow ports 14.

When a flow rate Q_{S} equal to 20% of the inlet 12 flow is drawn from the underflow ports 14 (in accordance with the present invention), the sand capacity of each cyclone can be calculated by multiplying the underflow flow rate by the underflow concentration (i.e. 20% of 10 m³/h*0.55=1.1 m³/h).

Thus, the sand capacity of each hydrocyclone in the system in zero net underfloor mode is 0.5 m³/h but when a 20% underflow flow rate is employed this figure increases to 1.1 m³/h.

However, because in the present embodiment of the invention the inlet 12 flow is increased by the addition of Q_{S} and Q_{M} a total of 15 hydrocyclones 13 are required in order to treat the original slurry flow of 90 m³/h. This has been calculated on the basis that 15 hydrocyclones can process a flow of 150 m³/h. Since Q_{S}=20% of 150 m³/h=30 m³/h and Q_{M}=20% of 150 m³/h=30 m³/h, the incoming flow excluding Q_{S} and Q_{M} is 150 m³/h−30 m³/h−30 m³/h=90 m³/h, as before.

The 15 hydrocyclones therefore allow a total sand flow of 15*1.1 m³/h=16.5 m³/h, which permits a sand concentration in the feed of (16.5 m³/h sand)/(90 m³/h slurry)=18.3% v/v.

The result of using this particular embodiment of the invention is therefore that the allowable concentration of sand in the slurry fed to the vessel 1 during the collection stage has increased from 5% v/v to 18.3% v/v therefore significantly increasing the capacity of the system 10 to separate high concentrations of sand from its inlet flow.

### NUMERICAL EXAMPLE 2

An approximate calculation will be described below in order to illustrate the effect of the present invention when operated during the sand cleaning stage.

It can be assumed that in one example during the collection stage, a hydrocyclone sand cleaning system has 9 cyclones each with an underflow port 14 diameter of 33 mm such that they can separate the sand in a slurry flow of 90 m³/h with a sand concentration of 5% v/v when running in zero net underflow mode.

To allow a comparison with the present invention to be carried out, the following assumptions are also made:
1. Eductor 6 is operated so as to produce a discharge flow of 90 m³/h to be similar to example 1. To achieve this Eductor 6 is operated so that it draws a flow Q_{6S} of 22.5 m³/h of slurry at a concentration of 55% by volume from the sand discharge port 3 of the vessel 1, and draws a flow Q_{6M} of 67.5 m³/h of motive water from pipe 9.
2. Eductor 43 is operated so that the flow rate Q_{S} is 20% of the feed flow through inlet 12 and a motive water flow Q_{M} of 20% of the feed flow is also required.

The amount of sand drawn from the vessel can be calculated by multiplying the eductor suction flow Q_{6S} by its concentration. 22.5 m³/h*0.55=12.375 m³/h.

The total flow discharged from the eductor is 90 m³/h, so the sand concentration at this point is 12.375/90=13.75% v/v.

If the invention is not employed, this flow would be fed to 9 cyclones and their feed concentration would be 13.75% v/v and the flow drawn from the underflow of the hydrocyclones is equal to Q_{6S}, which is 22.5 m³/h so if the hydrocyclone separates all the sand fed to it the sand concentration in the hydrocyclone underflow is 12.375/22.5=55% v/v

If the invention is employed, Q_{S}=30 m³/h and Q_{M}=30 m³/h (30 m³/h is 20% of the total flow of 150 m³/h) and 15 hydrocyclones are provided.

The slurry flow drawn from the vessel is still 22.5 m³/h with a sand content of 12.375 m³/h but the total flow fed to the cyclones is now 90+30+30=150 m³/h, and the flow drawn from the underflow of the hydrocyclones is 22.5+30=52.5 m³/h.

The hydrocyclones now receive a feed which is at a concentration of 12.375/150=8.25% v/v, and if the hydrocyclone separates all the sand fed to it, the sand concentration in the hydrocyclone underflow is 12.375/52.5=23.57% v/v

The result of using this embodiment of the invention is that the concentration of the feed to the hydrocyclones has been reduced from 25% v/v to 8.25% v/v and the concentration of the underflow of the hydrocyclones has been reduced from 55% v/v to 23.57% v/v both of which will improve their separation efficiency so that less sand is lost in their overflows.

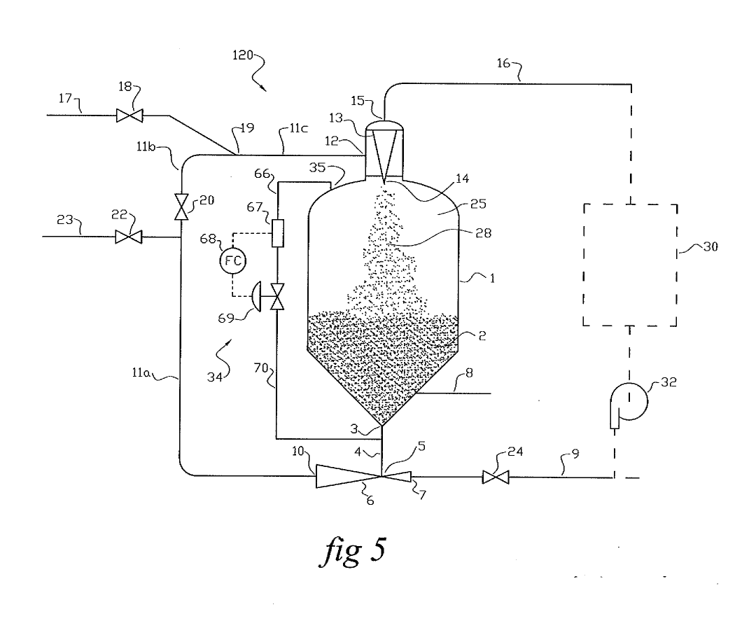

A second embodiment of the invention is shown in FIG. 4. In this embodiment the cleaning system 110 comprises a different fluid extractor 34. More specifically, the eductor 43 and the piping 37, 39 and valve 38 which fed high pressure water into the eductor 43 are not present. In their place, a pump 50 is provided which draws, via extractor pipe 36, a flow of relatively sand-free water at a flow rate which shall again be identified as Q_{S} from the extraction port 35 of the vessel 1 at low pressure. A treatment stage 51 may be inserted in pipe 36 to treat the fluid before entering pump 50. The treatment stage may include one or more of filtration, hydrocyclone separation, addition of chemicals, settling or the like The pump 50 delivers the water at an intermediate pressure into pipe 44 which, as above, flowing into pipe lie joining the slurry already in the line before flowing into the inlet 12 of the hydrocyclone 13. This embodiment of the invention increases the underflow flow rate of the hydrocyclone 13 and dilutes the feed to the hydrocyclone 13 and therefore has the same benefits as described above in relation to the first embodiment.

A third embodiment of the invention is shown in FIG. 5. In this embodiment the cleaning system 120 comprises an alternative fluid extractor 34. More specifically, the relatively sand-free water is drawn at a flow rate of Q_{S} from the extraction port 35 in the upper portion of the vessel I and is delivered into conduit 4 via extraction pipes 66 and 70 to deliver the water into the suction port 5 of the eductor 6 serving as the sand extractor. An optional flow control loop may be provided in the pipes 66 and 70 and may comprise a flow meter 67, a flow controller 68 and flow control valve 69.

In this embodiment, the capacity of eductor 6 may be increased so that it can draw the same quantity of sand from the vessel 1 as in the previous embodiments, as well as the additional flow of relatively sand-free water from pipe 70. This embodiment of the invention can also increase the underflow flow rate and dilute the feed to the hydrocyclone 13 and therefore has the same benefits as the above two embodiments, however the beneficial effects only occur in this instance, when the eductor 6 is operating. It may be necessary to incorporate a means of flow control into the pipe 66 to control the water flow rate because the pressure drop causing the flow of water in the pipe 66 will depend on the changeable pressure drop across the layer of settled sand 2 in the vessel 1.

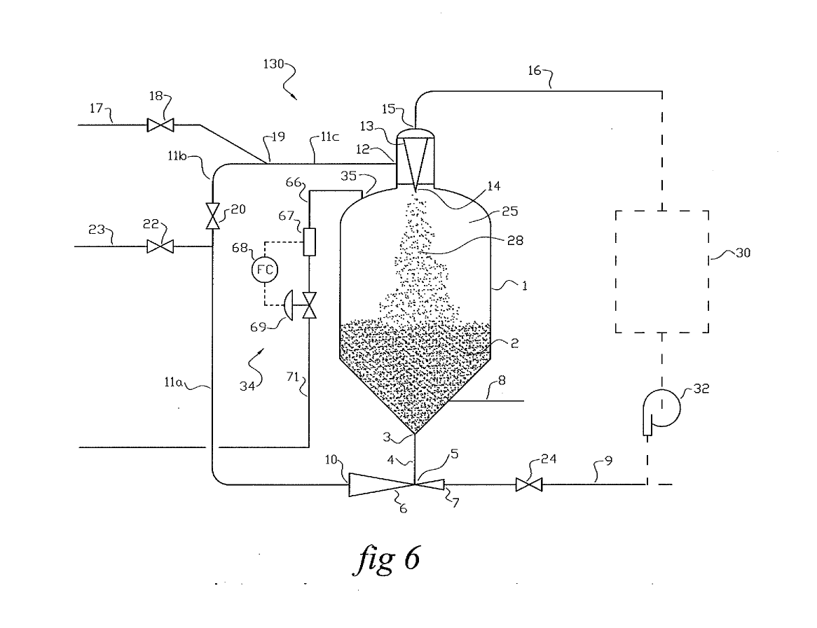

A fourth embodiment of the invention is shown in FIG. 6. In this embodiment the cleaning system 130 comprises a variant of the fluid extractor 34 described above in relation to FIG. 5. In this case, the only difference is that the pipe 70 leading to the suction port 5 of the eductor 6 via the conduit 4 has been replaced by a discharge pipe 71. Thus, in this embodiment, the relative sand-free water extracted from the vessel 1 is not delivered to the suction port of the eductor 6 but is instead discharged from the system 130. Accordingly, this embodiment of the invention only increases the underflow flow rate and does not dilute the feed to the hydrocyclone 13. It therefore only provides some of the benefits described above in relation to the first embodiment.

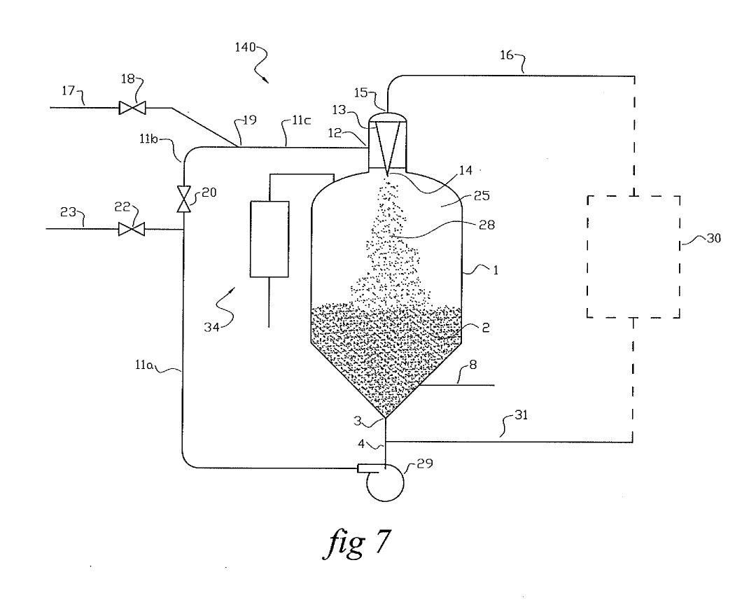

A fifth embodiment of the invention is shown in FIG. 7 and relates to a cleaning system 140 in which any of the fluid extractors 34 described above may be employed. However, in this embodiment the sand extractor comprises a pump 29 instead of the eductor 6. In this case, a controlled flow of water 31 must be added to the sand entering the pump from the conduit 4 to set the concentration of the slurry delivered into pipe 11a (and subsequently to the hydrocyclone 13). An advantage of this system is that high pressure motive water is not required since the water 31 can be supplied at the same low pressure as the vessel 1. However, a disadvantage of this system is that the pump 29 must be of a specialised design and construction suitable for pumping slurry and it is not available in a wide range of material options or design pressures, it is also more expensive than a standard pump, and will require regular replacement of wearing parts giving a higher operational cost than a standard pump.

It will be appreciated by persons skilled in the art that various modifications may be made to the above embodiments without departing from the scope of the present invention. For example, features described in relation to one embodiment may be incorporated into another embodiment and vice versa.

1. A cleaning system for hydrocyclone sand cleaning, comprising:
a hydrocyclone for receiving a slurry containing sand to be cleaned;
a vessel for receiving sand exiting the hydrocyclone and having a sand discharge port for permitting sand to be discharged from the vessel; and
a fluid extraction arrangement configured for extracting fluid from the vessel at a location between the hydrocyclone and the sand discharge port to permit an increased flow rate of sand into the vessel.

2. The cleaning system according to claim 1, wherein the fluid extraction arrangement comprises or defines an extraction port located between the hydrocyclone and the sand discharge port.

3. The cleaning system according to claim 2, wherein the extraction port is located above an expected maximum level of sand when it has accumulated in the vessel.

4. The cleaning system according to claim 2, wherein the extraction port is provided in an upper portion of the vessel.

5. The cleaning system according to claim 2, wherein the extraction port is formed or provided on a wall of the vessel.

6. The cleaning system according to claim 2, wherein the extraction port is defined within the vessel.

7. The cleaning system according to claim 1, wherein the fluid extraction arrangement comprises an extraction conduit system extending from the vessel.

8. The cleaning system according to claim 1, wherein the fluid extraction arrangement is configured to discharge at least a portion of fluid extracted from the vessel from the cleaning system.

9. The cleaning system according to claim 1, wherein the fluid extraction arrangement is configured to recycle at least a portion of fluid extracted from the vessel within the cleaning system.

10. The cleaning system according to claim 9, wherein the fluid extraction arrangement is configured to feed extracted fluid into the sand slurry prior to or on entry of the slurry into the hydrocyclone.

11. The cleaning system according to claim 1, wherein the fluid extraction arrangement is configured to permit passive extraction of fluid from the vessel.

12. The cleaning system according to claim 1, wherein the fluid extraction arrangement is configured to permit active extraction of fluid from the vessel.

13. The cleaning system according to claim 1, wherein the fluid extraction arrangement comprises flow control equipment configured to draw fluid from the vessel.

14. The cleaning system according to claim 1, wherein the fluid extraction arrangement comprises a fluid drive apparatus or means.

15. The cleaning system according to claim 1, wherein the fluid extraction arrangement comprises a dedicated fluid drive apparatus or means provided exclusively for use in actively extracting fluid from the vessel.

16. The cleaning system according to claim 1, wherein the fluid extraction arrangement comprises or utilises a shared fluid drive apparatus or means.

17. The cleaning system according to claim 14, wherein the fluid drive apparatus or means defines an inlet configured to receive or extract fluid from the vessel, and an outlet configured to at least one of discharge fluid from the cleaning system and recycle fluid within the cleaning system.

18. The cleaning system according to claim 1, wherein the fluid extraction arrangement comprises an eductor defining a suction port in fluid communication with the vessel.

19. The cleaning system according to claim 18, wherein the eductor defines a motive fluid port in fluid communication with a motive fluid source.

20. The cleaning system according to claim 19, wherein the motive fluid port is configured to receive fluid from the hydrocyclone.

21. The cleaning system according to claim 1, wherein the fluid extractor arrangement comprises a pump.

22. The cleaning system according to claim 1, further comprising a sand extraction arrangement configured for use in extracting sand from the vessel via the sand discharge port.

23. The cleaning system according to claim 22, wherein the sand extraction arrangement comprises a drive apparatus or means in communication with the sand discharge port.

24. The cleaning system according to claim 23, wherein the drive apparatus or means of the sand extraction arrangement is associated with the fluid extraction arrangement and is configured for both extracting fluid as a function of the fluid extraction arrangement, and extracting sand as a function of the sand extraction arrangement.

25. The cleaning system according to claim 22, wherein the sand extraction arrangement comprises an eductor or a pump arranged to extract sand through the discharge port of the vessel.

26. The cleaning system according to claim 22, wherein a fluid input is provided to assist the flow of sand through the sand extraction arrangement.

27. The cleaning system according to claim 26, wherein the fluid input is connected to an external fluid supply, an overflow port of the hydrocyclone and/or a discharge or output of the fluid extractor arrangement.

28. The cleaning system according to claim 27, wherein a fluid treatment device is connected to the fluid input to clean fluid flowing from the external fluid supply, the overflow port of the hydrocyclone and/or the fluid extractor arrangement.

29. A method for use in cleaning sand, comprising:
feeding a slurry containing sand to be cleaned into a hydrocyclone;
allowing sand to exit the hydrocyclone into a vessel below, the vessel having an discharge port for the sand; and
extracting fluid from the vessel from a position between the hydrocyclone and the discharge port to permit an increased flow rate of sand into the vessel.

30. The method according to claim 29, wherein the fluid is extracted from an upper portion of the vessel.

31. The method according to claim 29, further comprising diluting the slurry prior to or on feeding the slurry into the hydrocyclone.

32. The method according to claim 31, wherein the slurry is diluted by the extracted fluid.
